(19) United States
(12) Patent Application Publication
(10) Pub. No.: US 2025/0265817 A1
(43) Pub. Date: Aug. 21, 2025

(54) METHOD FOR DETECTING HUMAN OCCUPANCY AND ACTIVITY IN A WORKSPACE

(71) Applicant: VergeSense, Inc., San Francisco, CA (US)

(72) Inventors: Kelby Green, San Francisco, CA (US); Dan Ryan, San Francisco, CA (US); Tung Hoang, San Francisco, CA (US)

(21) Appl. No.: 19/072,929

(22) Filed: Mar. 6, 2025

Related U.S. Application Data
(63) Continuation-in-part of application No. 19/038,554, filed on Jan. 27, 2025.
Application No. 19/038,554 is a continuation of application No. 18/535,881, filed on Dec. 11, 2023, now Pat. No. 12,243,289.
Application No. 18/535,881 is a continuation of application No. 18/116,252, filed on Mar. 1, 2023, now Pat. No. 11,875,552.
Application No. 18/116,252 is a continuation of application No. 17/033,462, filed on Sep. 25, 2020, now Pat. No. 11,620,808.
(60) Provisional application No. 62/906,022, filed on Sep. 25, 2019.

(51) Int. Cl. G06V 10/764; G06F 18/2411; G06V 10/20; G06V 10/44; G06V 10/50; G06V 10/60; G06V 10/82; G06V 20/52; G06V 40/20

(52) U.S. Cl. CPC G06V 10/764; G06F 18/2411; G06V 10/255; G06V 10/44; G06V 10/50; G06V 10/60; G06V 10/82; G06V 20/52; G06V 40/20

(57) ABSTRACT

One variation of a method includes: accessing a first occupancy definition associating an occupied state, a standing condition, and a first object pairing; accessing an image recorded at a first sensor block and depicting a first desk in the workspace; detecting a first object of a first object type depicted in the image proximal the first desk; detecting a second object of a second object type depicted in the image proximal the first desk; and, in response to the first object pairing specifying the first object type and the second object type and in response to the first object falling within a first distance range of the second object, associating the first desk with the occupied state and the standing condition at the first time according to the first occupancy definition.

### CROSS-REFERENCE TO RELATED APPLICATIONS

This application is a continuation-in-part of U.S. patent application Ser. No. 19/038,554, filed on 27 Jan. 2025, which is a continuation of U.S. patent application Ser. No. 18/535,881, filed on 11 Dec. 2023, which is a continuation of U.S. Pat. No. 11,875,552, filed on 1 Mar. 2023, which is a continuation of U.S. Pat. No. 11,620,808, filed on 25 Sep. 2020, which claims the benefit of U.S. Provisional Application No. 62/906,022, filed on 25 Sep. 2019, each of which is incorporated in its entirety by this reference.

This application is related to U.S. Pat. No. 10,742,940, filed on 7 May 2018, which is incorporated in its entirety by this reference.

### TECHNICAL FIELD

This invention relates generally to the field of workplace monitoring and, more specifically, to a new and useful method for detecting human occupancy and activity in a workspace in the field of workplace monitoring.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

FIG. 4 is a schematic representation of a system;

FIG. 5 is a flowchart representation of one variation of the method; and

FIG. 6 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

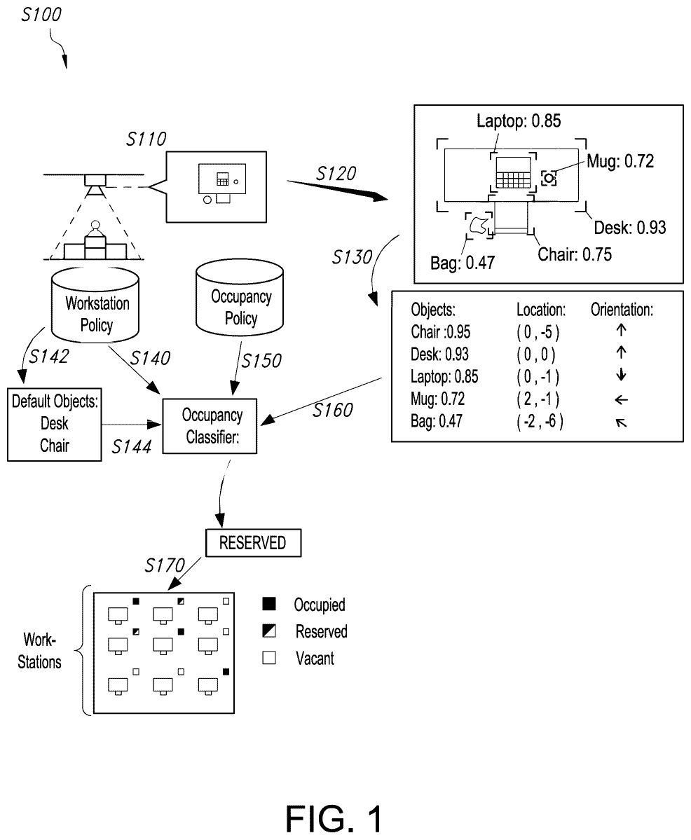

As shown in FIG. 1, a method S100 includes: recording a first image at a sensor block at a first time, the sensor block defining a field of view intersecting a workspace and encompassing a workstation in the workspace in Block S110; detecting a set of objects in the first image based on an object classification model in Block S120; generating a feature vector for the first image based on the set of objects, the feature vector including a confidence value and a location of each object in the set of objects in Block S130; accessing a workstation template for the workspace, the workstation template defining a set of default objects for each workstation in the workspace in Block S140; identifying a subset of objects including an intersection of the set of default objects and the set of objects in Block S142; removing the subset of objects from the feature vector in Block S144; accessing an occupancy template for the workspace, the occupancy template defining a set of significant objects in Block S150; classifying the workstation as occupied based on the feature vector and the set of significant objects in Block S160; and rendering a representation of the workstation at a workspace interface, the representation indicating occupancy of the workstation in Block S170.

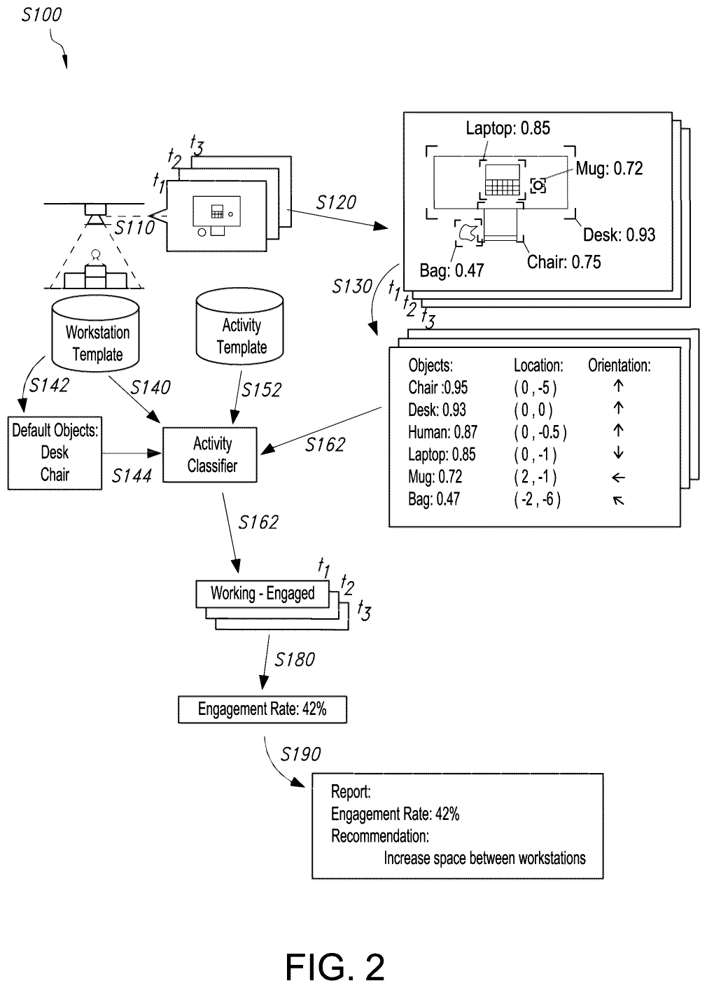

As shown in FIG. 2, one variation of the method S100 includes, periodically, during a first time period: recording an image at a sensor block, the sensor block defining a field of view intersecting a workspace and encompassing a workstation in the workspace in Block S110; detecting a set of objects in the image based on an object classification model in Block S120; generating a feature vector for the image based on the set of objects, the feature vector comprising a classification and a location of each object in the set of objects in Block S130; accessing a workstation template for the workspace, the workstation template defining a set of default objects in the workspace in Block S140; identifying a subset of objects comprising an intersection of the set of default objects and the set of objects in Block S142; removing the subset of objects from the feature vector in Block S144; accessing an activity template for the workspace, the activity template defining a set of significant objects in Block S152; classifying human activity at the workstation based on the feature vector and the set of significant objects to generate an activity classification in Block S162; and aggregating the activity classification into a set of activity classifications for the workstation in Block S180. This variation of the method S100 also includes generating a use-of-space recommendation based on the set of activity classifications in Block S190.

Another variation of the method S100 includes: recording a first image at a sensor block at a first time, the sensor block defining a field of view intersecting a workspace and encompassing a workstation in the workspace in Block S110; detecting a set of objects in the first image based on an object classification model in Block S120; generating a feature vector for the first image based on the set of objects, the feature vector including a classification and a location of each object in the set of objects in Block S130; accessing a workstation template for the workspace, the workstation template defining a set of default objects in the workspace in Block S140; identifying a subset of objects including an intersection of the set of default objects and the set of objects in Block S142; removing the subset of objects from the feature vector in Block S144; accessing an activity template for the workspace, the activity template defining a set of significant objects in Block S152; classifying human activity at the workstation based on the feature vector and the set of significant objects to generate an activity classification in Block S162; and generating a use-of-space recommendation based on the activity classification in Block S190.

### 2. Applications

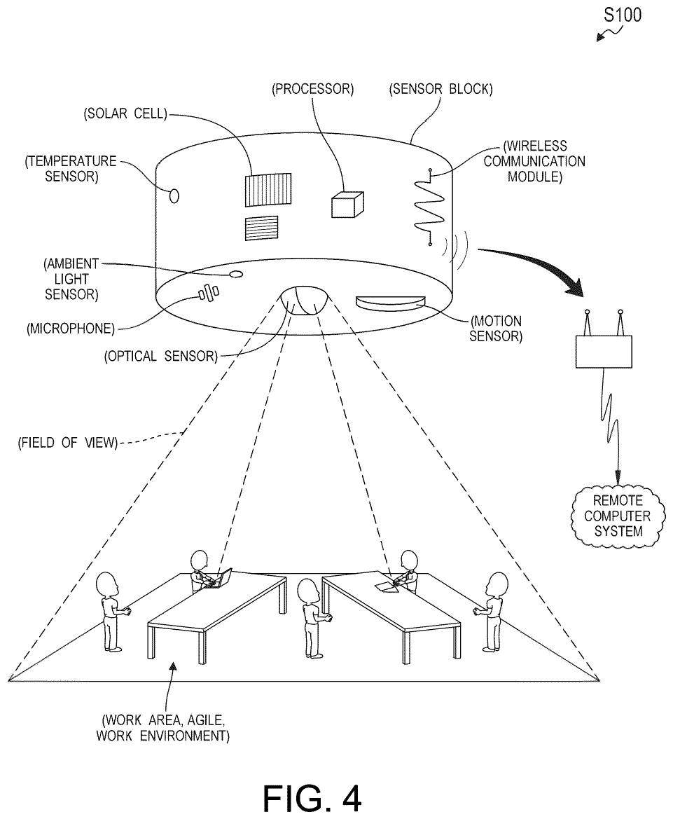

Generally, the method S100 can be executed within a workspace—such as within a conference room, an agile work environment, a cafeteria, or a lounge, etc. within a facility—to monitor changes in human occupancy in the workspace, to update schedulers or resource managers regarding the occupancy state of various workstations within the workspace and the activities performed by human occupants of these workstations, and to control various actuators throughout the workspace based on these changes in human occupancy. As shown in FIG. 4, Blocks of the method S100 can be executed by a system including: a set of sensor blocks deployed throughout the facility; a remote computer system that updates schedulers, serves prompts for managers or administrators based on occupancy changes and states of spaces within the workspace; and local gateways arranged throughout the facility that are configured to pass data between these sensor blocks and the remote computer system.

In particular, each sensor block can include an optical sensor (e.g., a camera and/or various other sensors) and can be configured to mount to a wall, ceiling, or other surface within the field of view of the optical sensor facing an area of interest within the facility. For example, a sensor block can be arranged overhead and facing downward over a conference table in a conference room or arranged overhead and facing downward over a cluster of desks in a workspace within the facility.

In order to accurately detect the occupancy state of a workstation in a workspace immediately upon deployment in a new workspace, the system can: record images of the workstation; extract features from these images; and classify the occupancy of the workstation (as occupied, vacant, or reserved) and/or the activity of humans occupying the workstation based on the extracted set of features. However, due to the diverse nature of workspaces across companies, facilities, industries, etc. an image classification model can fail to accurately detect the occupancy state of a workstation. For example, at a first workspace, each workstation may be equipped with a keyboard, mouse, monitor, and wooden desk while, at a second workspace, each workstation may include a metal desk occupied solely by a charging station for a laptop computer. In this example, a general image-based classification model may require a large number of diverse training examples and/or significant training time to identify optical features that signal occupancy or vacancy in both workspaces. Additionally, such an image classification model may also require high per-inference runtime and power requirements, which may compromise performance in an edge computing environment. However, the method S100 can eliminate sources of overfitting that may confound image-based classification models in order to improve initial classification of human occupancy and activity in new workspaces without requiring additional training examples.

The system executes an object detection model to extract a set of features representing objects detected in each image captured by a sensor block. Each feature in the set of features includes an object classification describing the type of object depicted in the image and a location (i.e., a pixel location) of the object within the image. The system can include an object detection model that is configured to detect workplace specific objects such as laptop computers, desktop computers, monitors, keyboards, coffee cups, coats, backpacks, or any other object that may be common in a workspace. Upon receiving an input image, the system can execute the object detection model to output a feature vector of a set of detected objects including the classification of each object (and associated confidence values) in addition to a location, an orientation, and/or a bounding region representing the object within the image.

The system can then access a workstation template for the workspace (e.g., defined by an administrator of the workspace) to identify specific object types that are supplied by default at each workstation (i.e., a set of default objects). Additionally, the system can access an occupancy template (e.g., defined by an administrator for the workspace) that defines objects and/or combinations of objects that, when present at a workstation, indicate occupancy of the workstation. For example, an administrator of a first workspace may dictate that a workstation is classified as occupied while a worker's laptop is present at the workstation; and another administrator of a second workspace may dictate that a workstation is classified as occupied exclusively when a human is present at the workstation. Likewise, the system can access activity templates that define objects and/or combinations of objects that, when present at a workstation, indicate particular human activities, such as working or presenting (e.g., in a conference room).

Thus, the system can access the workstation template of a new workspace and “mute” specific objects in the feature vector that persist (e.g., are always present) in the workspace. Likewise, the system can access an occupancy template and boost the importance of those particular objects when they are detected in an image of a workstation. Therefore, the system can provide an accurate classification as to whether a workstation in the new workspace is occupied, based on an overhead image of the workstation, while bypassing the typical process of retraining an image-based classification model based on a new set of images taken from the new workspace.

Once the system applies the workstation template and/or the occupancy template to the feature vector generated by the object classification model, the system can execute an occupancy classification model in order to classify the workstation in the image as vacant, occupied, or reserved. The occupancy classification model receives an input feature vector and classifies the workstation in the image as occupied or vacant based on the classification, location, and orientation of objects in the image. The occupancy classification model differs from an image-based classification model as it does not consider optical features of the image directly and instead classifies the occupancy of the workstation based on detected objects in the scene. Due to the reduction in feature “noise” when compared to image-based classification models, the system executing the occupancy classification model can more robustly classify the occupancy of workstations in a new workspace (i.e., a workspace that was not a source for training images of the object classification model and/or the occupancy classifier).

Upon classification of a workstation, the system can report the result to a scheduler or resource manager regarding the status of the workstation, thereby enabling employees in the workspace to select a workstation in a workspace based on the classifications of those workstations. Additionally, the system can render (at a native application executing on a computational device), in real time, an employee interface that can display the relative locations of workstations within a workspace and an indication of each workstation's occupancy state in order to guide employees to vacant workstations within the workspace. Furthermore, the system can expose additional information regarding the objects detected at a particular workstation. For example, the system can indicate that a particular workstation is reserved (i.e., occupied without a human current present) due to the presence of a laptop computer or other personal effects at the workstation. Therefore, an employee in the workspace may, in the absence of any vacant workstations, identify a reserved workstation via a workspace interface and request that the person occupying the reserved workstation allow the employee to use the workstation.

In one implementation, the system can also store objects that have been detected at workstations classified as occupied by the system. Therefore, the system can provide statistics and/or other guidance on what objects are frequently left occupying a workstation, thereby enabling an administrator to adjust occupancy policies and/or issue advisories regarding employees' use of workstations in the workspace. Alternatively, the system can adjust an occupancy template over time to more accurately represent an occupied workstation, thereby further improving occupancy classification of the system.

In another implementation, the system can label images as occupied and/or vacant in order to prepare a training data set for an image-based classification model that is trained specifically for a particular workspace. Thus, the system can serve as a temporary generalized solution that can aid in training a more permanent image-based classification model, specific to the particular workspace.

Generally, the system is described herein as being executed with reference to a single workstation within a workspace. However, the system can execute Blocks of the method S100 multiple times for a single image in order to classify occupancy of multiple workstations within the field of view of a single sensor block. Additionally or alternatively, the system can execute Blocks of the method S100 multiple times for a single image in order to classify the activities of multiple humans present within the field of view of the sensor block. Furthermore, the system can execute Blocks of the method S100 multiple times in succession in order to aggregate individual occupancy classification or activity classifications into comprehensive space utilization data. The system can then generate use-of-space recommendations relevant to particular workstations within the workspace based on the aggregated space utilization data.

### 3. System

Generally, as shown in FIG. 4, the method S100 can be executed by one or more elements (e.g., a sensor block in the set of sensor blocks and/or a remote computer system) to: record images of workstations within the workspace; detect objects within those images; generate a feature vector based on the detected objects; and classify workstations as occupied or vacant. Once installed throughout the space, these sensor blocks can collect optical data, such as in the form of a color image per ten-minute interval, and a local or remote computer system can classify a workstation within the image as either occupied or vacant. The system can include one or more computational devices connected via a network (e.g., the Internet, LAN, etc.) to a local gateway. Furthermore, the local gateway is wirelessly connected to each of the sensor blocks to facilitate the receipt of images from the sensor blocks by the system.

### 3.1 Optical Sensor

As described in U.S. application Ser. No. 15/973,445 and as shown in FIG. 4, a sensor block can include: an optical sensor, such as a color camera; a battery; a wireless communication module configured to broadcast image data recorded by the optical sensor; and a controller configured to selectively wake, trigger the optical sensor to record an image, write various metadata to the image, and then queue the wireless communication module to broadcast the image to the local gateway for processing. Additionally, in some implementations, the sensor block can execute the object classification model at a processor on the sensor block and transmit the feature vector generated from the image to the local gateway. The optical sensor, battery, controller, and wireless communication module, etc., can be arranged within a single housing configured to install on a flat surface, such as a wall or ceiling, with the field of view of the optical sensor facing outwardly from the flat surface.

The optical sensor defines a field of view as a function of working distance from an adjacent surface. For example, a sensor block arranged on a ceiling with the optical sensor facing downward and toward an open floor can define a field of view as a function of the ceiling height of the space at the location of the sensor block, wherein the field of view of the optical sensor increases with increased ceiling height. In this example, the controller can store various optical sensor properties, such as lens focal length and image sensor block size sets, which may define a relationship between field of view and working distance (e.g., ceiling height) of the optical sensor. The controller can also store a unique identifier (e.g., a UUID, MAC address, IP address, or other wireless address, etc.) and write this unique identifier, a timestamp, and optical sensor properties to an image or feature vector prior to passing the image or feature vector to the wireless communication module for transmission to the local gateway. Once commissioned to a space, the sensor block can wake, trigger the optical sensor to record an image, compile metadata with the image, transmit the image and metadata to a local gateway, return to a sleep state (e.g., to limit power consumption), and repeat this process on a regular interval, such as once per ten-minute period. Multiple (e.g., dozens, hundreds) instances of the sensor block can be installed in a space and configured according to the method S100.

### 3.2 Local Gateway

The system can also include a local gateway: configured to receive images and/or feature vectors from sensor blocks nearby via wireless communication protocol or via a local ad hoc wireless network; to detect objects within the images by executing the object classification model (in implementations wherein this step was not completed locally at the sensor blocks); to generate a feature vector representing the objects in the images and to offload these feature vectors to inform understanding, further use, and/or maintenance, etc., of the space, such as over a computer network or long-range wireless communication protocol. The sensor blocks and/or the local gateway can transform optical images into feature vectors by implementing the object classification model to detect objects in the optical images, such as humans, chairs, desks, tables, or other objects of interest, and to pair each detected and classified object of interest with a location and orientation in the field of view of the optical sensor that recorded the corresponding image.

In an alternative implementation, the local gateway can transform optical images received from the sensor into feature-space images before transmitting the images to the system over a network. In this implementation, the sensor blocks transmit the optical images to the local gateway, and the local gateway implements the aforementioned computer vision techniques.

After generating a feature vector from the optical images, the gateway can then offload the classification and relative location (and orientation) of the object of interest to the system for classification as either occupied or vacant.

### 3.3 Computer System

The system further includes a remote computer system, such as a remote server, configured to receive feature vectors from one or more gateways installed in a space and to: access workstation policies and/or occupancy policies for the workspace; classify the workstation corresponding to the feature vector; render a representation of the occupancy of the work station at a workspace interface; and/or store the feature vectors in association with the occupancy of the workstation. Additionally, the remote computer system can train an image-based classification model for a workspace based on the outputs of the occupancy classifier.

(Alternatively, various Blocks of the method S100 can be executed locally by one or more gateways also installed in the space.)

### 4. Commissioning, Installation, and Onboarding

The system executes the method S100 upon completion of a commissioning, installation, and onboarding process for the set of sensor blocks in a particular workspace. In order to detect occupancy and vacancy of a workstation, the system relies on coverage of each workstation in the workspace within the field-of-view of an optical sensor block in the set of sensor blocks. Thus, the sensor blocks may be installed across the ceiling and/or walls of a workspace such that the fields-of-view of the optical sensors of the sensor blocks encompass each of the workstations of interest within the workspace. Additionally, the system can guide an administrator of the workspace through an onboarding interface that enables the administrator to identify workstations across the workspace covered by the set of sensor blocks. In one implementation, upon installation of the set of sensor blocks over a workspace, the system records an image with each of the sensor blocks and renders the set of images via a native application. An administrator can then input a set of bounding regions (e.g., bounding boxes) or image masks for each image wherein each bounding region defines a workstation within the image. Therefore, the system can receive input regarding the location of workstations relative to the field of view of the camera. In another implementation, the system can also receive input from the administrator regarding the type of workstation corresponding to each bounding region. For example, via a native application, the system can receive input from an administrator defining a particular workspace as a conference room while defining another workspace as an agile desk area. The system can then receive, via the native application, the location of each chair within the conference room or each chair and desk location within an agile work environment and record these chair locations as workstation locations.

In one implementation, the system can automatically detect desks and chairs within the workspace and automatically designate these chairs and desks as workstations within the workspace, via the object detection model further described below.

### 5. Object Classification Model

As shown in FIG. 1, the system can: detect a set of objects in the first image based on an object classification model in Block S120; and generate a feature vector for the image based on the set of objects, the feature vector including a confidence value and a location of each object in the set of objects in Block S130. More specifically, the system can execute the object detection model on an image recorded at a sensor block to identify various common objects within the image. Thus, the system can obtain a set of features representing objects in the image while reducing noise introduced to the image by lighting conditions, blur, colors, or other optical and/or overtraining-related effects. In one implementation, the object detection model is a pre-trained convolutional neural network, configured to detect a standard set of objects. For example, the object detection model can be trained to detect: humans, chairs, desks, computer monitors, keyboards, electronic mice, laptop computers, smartphones, computer and/or phone chargers, mugs and/or cups, purses, bags, notebooks, pens and/or pencils; or any other item that is common in the workspace. In one example, the system can detect a set of objects in the image based on the object classification model, wherein the set of objects includes at least one object in a group of objects including: humans; chairs; desks; electronic displays; keyboards; electronic mice; laptop computers; smartphones; tablet computers; desktop computers; electronic chargers; electronic charging cables; whiteboards; pairs of headphones and/or earphones; mugs and/or cups; items of tableware; eating utensils; notebooks and/or paper; writing implements; bags; and articles of clothing.

In this implementation, the object detection model can be specifically trained to detect and classify objects at a similar camera angle (e.g., an overhead camera angle) and in images of a similar resolution to those images recorded by the optical sensor of the sensor block.

Upon detecting an object in an image, the object detection model can generate a bounding region in the image occupied by the object, a location of the object relative to the image (e.g., the field of view of the optical sensor), and an orientation of the object relative to the bounding region. The system can then convert these values output by the object classification model to a feature vector that identifies each object detected in the image as a feature in the feature vector. The feature vector can also include a confidence value for each object classified by the object detection model, thereby enabling the system to better weigh the influence of particular objects during execution of the occupancy classifier and/or the activity classifiers further described below.

In one implementation, the object detection model can be stored locally at each sensor block such that each sensor block can generate feature vectors locally, thereby obviating the need to wirelessly transmit images to the local gateway and/or remote computer system. Therefore, the system can reduce the battery consumption utilized in transmitting comparatively large images (when compared with a feature vector) and can circumvent privacy concerns of transmitting images of humans wirelessly within the workspace.

In another implementation, the object detection model can identify a location of a chair and/or desk in the field of view of an optical sensor and define a centroid and/or boundary of the workstation based on the location of the chair and/or desk in the image. In this implementation, the object detection model can then calculate a location for each of the other objects detected in an image relative to the centroid location of the workstation. By generating a feature vector including these relative locations, the system may provide improved classification results via the occupancy classifier.

In yet another implementation, the system can execute an object classification model that classifies objects characterized by similar visual appearances and/or similar contextual implications for occupancy and/or activities performed by humans within the workspace. For example, the system can classify both bags and articles of clothing under a single category since they provide similar context for identifying occupancy of a desk within an agile desk environment. In this example, the system can train the object classification model to classify both of these types of items, when depicted in an image from a sensor block, as a single class of object. The system can classify other object classes, including multiple types of objects, such as a mobile device class representing smartphones and tablet computers and a small item class representing items less than a threshold size (e.g., too small to uniquely identify given the resolution of the sensor block). Thus, the system can identify an object as a member of an object class in a set of object classes including: a mobile device class representing smartphones and tablet computers; a miscellaneous clothing and bag class representing articles of clothing and bags; and a small item class representing items less than a threshold size.

In yet another implementation, the system can set a threshold confidence value characterizing objects represented within the feature vector. More specifically, the system can generate a feature vector for the first image based on the set of objects, the feature vector including the confidence value and the location of each object in a subset of objects from the set of objects for which the confidence value of the object exceeds a threshold confidence value. Thus, the system can exclude objects detected with low confidence (i.e., characterized by a confidence value less than the threshold confidence value) by the object classification model in order to further reduce noise present in the feature vector.

In one example of this implementation, the system can access the threshold confidence value for the feature vector based on the time of day at which the system recorded an image at a sensor block. For example, the system can increase the threshold confidence value, thereby decreasing noise within the feature vector during times of high occupancy within the workspace. Additionally or alternatively, the system can decrease the threshold confidence value, thereby increasing sensitivity of the feature vector during times of low occupancy within the workspace.

In another example of this implementation, the system can access the threshold confidence value for the feature vector based on a lighting condition present in an image recorded at the sensor block. For example, the system can detect a low brightness range for the image recorded at the sensor block and, in response, decrease the threshold confidence value, thereby increasing the sensitivity of the feature vector in order to compensate for lower confidence output by the object classification model due to poor lighting conditions. Additionally or alternatively, the system can detect a high brightness range for the image recorded at the sensor block and, in response, increase the threshold confidence value, thereby decreasing noise within the feature vector in order to prevent detection of spurious objects due to high contrast within the image.

In yet another implementation, the system can access a set of object classification parameters for input to the object classification model in order to improve the accuracy of the object classification model across varied workspaces and workstations to which the system can be deployed. More specifically, the system can: access a set of object classification parameters including desk color, floor color, and wall color; and detect the set of objects in the image recorded by the sensor block based on the object classification model and the set of object classification parameters. Thus, the system can train the object classification model to identify objects in a variety of workspaces with varying color schemes, thereby further generalizing the model and preventing overfitting of the object classification model to a particular workspace. In one example, the system can train the object classification model based on a set of training images of objects, wherein the set of training images are color-shifted to reflect various possible color schemes that may be present within a workspace.

In yet another implementation, the system can train multiple separate object classification models such that each object classification model corresponds to a particular workspace context (e.g., a conference room context or an agile desk area context). The system can, therefore, identify different objects and/or classes of objects depending on the workspace context in which the sensor block is situated. For example, upon accessing a workspace context indicating that the sensor block is located within a conference room, the system can execute a conference room object classification model to detect a set of common conference room objects, such as whiteboards, whiteboard erasers, and/or electronic display monitors. The system can also train the conference room object classification model on furniture (e.g., chairs and tables) that is frequently located in conference rooms. Likewise, upon accessing a workspace context indicating that the sensor block is located over an agile desk area, the system can execute an agile desk object classification model to detect a set of common agile desk objects such as laptop docks, coats, hats, eyeglasses, and other personal effects. In another example, the system can access a workspace context that includes the geographical region in which the workspace is located in order to select an object classification model that is trained to detect objects common in the geographic region based on climate or cultural patterns. Thus, the system can: access a workspace context; and detect the set of objects in the first image based on the object classification model and the workspace context.

### 6. Workstation Template

As shown in FIG. 1, the system can access a workstation template for the workspace, the workstation template indicating a set of default features in Block S140. Generally, the system can receive a workstation template via input from an administrator regarding the items that are provided by default at each workstation within the workspace. More specifically, the workstation template can include a list of objects present at each workstation, independent of occupancy, and detectable by the object detection model. The system can, therefore, remove or reduce the weight of such objects when classifying occupancy of workstations in the workspace. In one implementation, the system can receive multiple workstation policies, each policy corresponding to a particular type of workstation identified in the workspace. Therefore, the system can receive information defining the types of objects that are present by default at each workstation in order to reduce the strength of those signals during classification of the occupancy of each workstation.

In one implementation, the system can access a set of workstation templates corresponding to the workspace context of the workspace. For example, the system can: access a workspace context of the workspace indicating that the workspace is a conference room; and, in response, access a set of workstation templates corresponding to conference rooms. Additionally or alternatively, the system can: access a workspace context of the workspace indicating that the workspace is an agile desk area; and, in response, access a set of workstation templates indicating objects present at various configurations of the agile desks within the agile desk area. Thus, the system can access a workstation template for the workspace based on the workspace context, the workstation template defining the set of default objects in the workspace.

In another implementation, the system can, prior to classifying occupancy of a workspace or activities of humans within the workspace, identify the type of workstation based on the object or arrangement of objects within the workstation by attempting to match the objects or arrangement of objects within the workstation to a set of workstation templates that are applicable to the workstation. Thus, the system can identify a type of the workstation based on the first image; and access the workstation template for the workspace based on the type of workstation, the workstation template defining the set of default objects in the workspace.

### 7. Feature Pruning

Generally, upon accessing a workstation template, the system can remove features in the feature vector that correspond to objects in the set of default objects. More specifically, the system can: identify a subset of objects including an intersection of the set of default objects and the set of objects in Block S142; and remove the subset of objects from the feature vector in Block S144. Thus, the system removes objects from consideration by the occupancy classifier or the activity classifiers that are provided by default to workstations within the workspace, thereby increasing the accuracy of these classifiers and preventing overtraining of these classifiers based on workstations in a training data set that include a particular set of default objects.

In one implementation, instead of completely removing the set of default objects from the feature vector, the system can reduce the weight of the default objects represented in the feature vector, thereby increasing the importance of other features in the feature vector. Alternatively, the system can include the set of default objects as an input to the occupancy classifier and/or the activity classifiers, thereby enabling the training processes for these classifiers to consider the set of default objects and adjust the relevant classifier accordingly. Upon executing the latter approach, the system increases the probability of overtraining, but if given an appropriately diverse training data set the system can increase accuracy when compared to previously described implementations.

### 8. Occupancy Template

Generally, the system can access an occupancy template for the workspace, the occupancy template indicating a set of occupancy signals in Block S150. The system can receive, via a native application or other interface, an occupancy template from an administrator of the system. Alternatively, the system can generate an occupancy template for a particular workspace over time upon deployment to a workspace. The occupancy template defines specific objects or conditional arrangements of objects that, if detected with greater than a threshold confidence, constitute occupancy or reservation of the workstation. In one implementation, the system can then establish occupancy logic based on the policy defined by an administrator. For example, the system can access an occupancy template that designates identification of a workstation as occupied if the system detects a human at the workstation. In another example, the system can access an occupancy template that defines occupancy of a workstation based on overlap between bounding regions of a human object and a chair object in the feature vector. In yet another example, the system can access an occupancy template that defines reservation of a workstation based on detecting a laptop computer within the bounding region of a desk at the workstation in the feature vector.

Although the system can implement classification logic according to the occupancy template, this approach may fail when a human or another overt sign of occupancy is not detected at the workstation. Therefore, the system can also execute an occupancy classifier specific to the occupancy template defined by the administrator. For example, the system can execute an occupancy classifier that has been trained according to the occupancy template (via labeling of training examples as occupied, vacant, or occupied with no human present). Thus, the system can store multiple occupancy classifiers, each trained to classify occupancy based on a particular occupancy template. Alternatively, the system can train a single occupancy classifier that ingests an occupancy template as input.

In one implementation, the system can access an occupancy template corresponding to the workspace context of the workspace in which the sensor block is located. For example, the system can access a first occupancy template corresponding to a conference room and a second occupancy template corresponding to an agile desk area. Therefore, the system can apply multiple occupancy templates corresponding to multiple workspaces within a facility in order to accurately detect occupancy of workstations within each workspace of a facility. Additionally, the system can access occupancy templates corresponding to other workspace contexts, such as the time of day at which the image was recorded, the weather, and/or time of year of the region in which the workspace is located. For example, in the morning, the system can access an occupancy template that includes a coffee mug in the set of significant objects due to a high correlation between the presence of coffee mugs and occupancy in the morning. In another example, the system can access an occupancy template that includes a coat overlapping with a chair as a significant arrangement of objects due to a high correlation between the presence of coats and occupancy in regions experiencing cold weather. Thus, the system can access the occupancy template for the workspace based on the workspace context, the occupancy template defining the set of significant objects.

### 9. Activity Templates

Generally, upon detecting humans (e.g., as objects represented in the feature vector), the system can access activity templates that define objects and/or conditional arrangements of objects that are correlated with particular human activities within the workspace. More specifically, the system can access an activity template for the workspace, the activity template defining a set of significant objects in Block S152. Thus, the system can more accurately classify particular activities of interest occurring within the workspace based on the objects and/or the arrangement of objects detected at each workstation within the workspace.

The system can access an activity template defining a set of significant objects and/or a configuration of significant objects correlated with the activity of engaged working. For example, the system can access an activity template that defines overlap between a bounding region of a human at a workstation and the bounding region of a desk, a chair, and a laptop as being correlated with an engaged condition of the human at the workstation. In another example, the system can access an activity template that defines overlap between a bounding region of a human at a workstation and a bounding region of a chair without overlap of the bounding region of the human and a bounding region of a laptop as correlated with a present (but not engaged) condition of the human at the workstation. In yet another example, in applications of the system in which the workspace is a conference room, the system can access activity templates defining a set of significant objects or arrangements of significant objects that are correlated with human activities, such as presenting, listening, and/or working (e.g., on a laptop). Thus, in addition to characterizing the occupancy rate of workstations within a workspace over time, the system can also characterize human activities within the workspace via activity templates and corresponding activity classifiers, further described below.

### 10. Occupancy Classifier

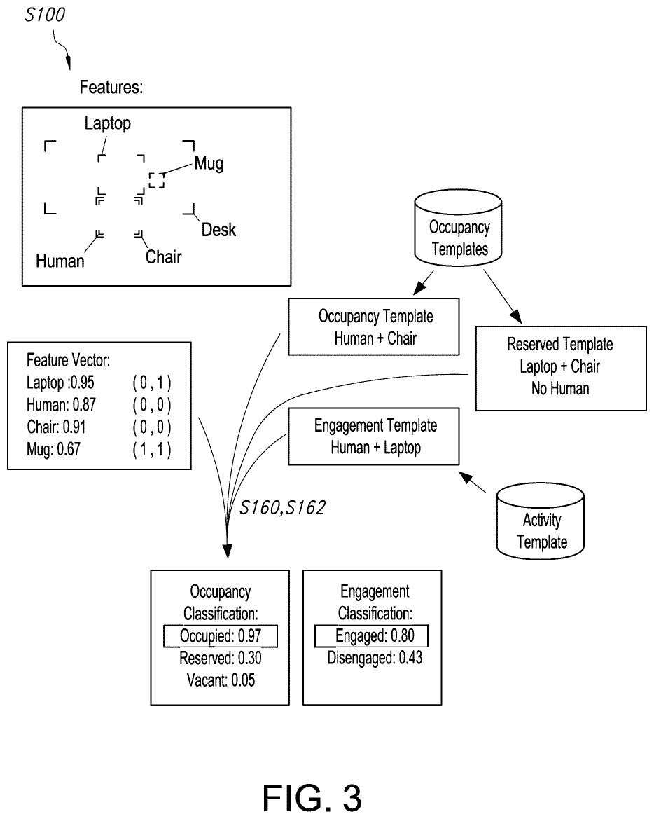

As shown in FIG. 3, the system can execute an occupancy classifier in order to classify occupancy of the workstation based on the feature vector. More specifically, the system can classify the workstation as occupied, reserved, or vacant based on the feature vector and the set of significant objects accessed via the occupancy template in Block S160. A classification of “occupied” indicates that a human is present at the workstation and/or that there is a high confidence of occupancy of the workstation. A classification of “vacant” indicates that there is no human present, and there are few signs or low confidence signs (if any) of occupancy at the workstation. A classification of “reserved” indicates that the workstation is likely occupied but that a human has not been explicitly detected at the workstation or that a human is likely to return to the workstation based on the objects detected at the workstation. For example, the system can classify a workstation as “reserved” if the system detects that a laptop and item of clothing are present at the workstation and that the chair corresponding to the workstation is askew but does not detect a human occupying the workstation. Thus, the system can classify the workstation as exhibiting an “occupied” condition based on the feature vector, the set of significant objects, and an occupancy classifier configured to classify the workstation according to one of a set of occupancy states including: a “vacant” condition; a “reserved” condition; and an “occupied” condition.

The system can, periodically (e.g., once every minute, five minutes, or ten minutes), over a time period (e.g., a week, a month, a year), classify the occupancy of the workstation within the workspace. The system can then aggregate this occupancy data over the time period to calculate an occupancy rate of the workstation, which can inform use-of-space recommendations generated by the system. More specifically, the system can: aggregate the occupancy state into the set of occupancy states for the workstation; and calculate a workstation occupancy rate based on the set of occupancy states.

In one implementation, the occupancy classifier can include an artificial neural network trained on a set of training examples, wherein each training example includes a feature vector generated by the object detection model and a label (provided by an administrator of the system based on an image corresponding to the feature vector). Therefore, the object classifier can be trained according to human intuition regarding the occupancy state of the workstation. Thus, by labeling each feature vector in the set of training examples according to occupancy definitions of an administrator for occupancy, vacancy, and reservation, the occupancy classifier can classify workstations in alignment with human intuition regarding workstation occupancy.

In another implementation, upon executing the occupancy classifier, the system generates a confidence value for each possible classification (e.g., occupied, vacant, and occupied with no human present). The system can then classify the current state of the workstation based on classification with the greatest confidence value greater than a confidence value threshold. Alternatively, upon executing the occupancy classifier, the system can: generate a single confidence value that a workstation is occupied; classify the state of the workstation as occupied when the confidence value is greater than a threshold score; classify the state of the workstation as reserved if the confidence value exceeds the threshold confidence value and no object in the feature vector is classified as a human with a greater than threshold confidence; and classify the state of the workstation as vacant if the confidence value is less than the threshold confidence value.

In yet another implementation, the system can execute an occupancy classifier that includes a rules-based classifier that classifies the state of the workstation based on the presence or absence of objects in the feature vector. For example, the rules-based classifier can: classify a workstation as occupied based on the presence of a human in the feature vector with greater than a threshold confidence value; classify a workstation as occupied without a human present if a laptop, smartphone, purse, or bag is detected with greater than a threshold confidence at the workstation; and otherwise classify the workstation as vacant.

### 10.1 Occupancy Threshold Selection

In one implementation, the system can dynamically select a confidence threshold for the occupancy classifier based on external signals, such as time of day, day of the week, number of humans currently present within the workspace, or any other signal accessible by the system. In one example, the system can decrease the confidence threshold for occupancy during peak working hours since the likelihood of occupancy is higher in the workspace overall. Additionally or alternatively, during less busy times of day, such as outside of working hours, the system can increase the threshold for occupancy detection. In another example, the system can measure, via integration with a sign-in or security system, the number of people in a workspace. In response to detecting a greater number of occupied workstations than the total number of people with access to the workspace, the system can increase the confidence threshold for occupancy such that the number of occupied workstations equals the number of people with access to the workspace.

### 11. Activity Classification

As shown in FIG. 3, the system can execute a set of activity classifiers (e.g., implemented as artificial neural networks or other machine learning models as described above with respect to the occupancy classifier) in order to classify activities being performed by humans present at workstations within the field of view of the sensor block. More specifically, the system can classify human activity at the workstation based on the feature vector and the set of significant objects to generate an activity classification in Block S162. The system can execute many activity classifiers in applications for which a human can be classified as performing multiple activities at the same time. Alternatively, the system can execute a single activity classifier to select a particular action for a set of mutually exclusive actions. Thus, in response to classifying a workstation as occupied (or simply identifying a human near the workstation), the system can interpret activities performed by humans near these workstations and present these activities to administrators of the workspace.

In one implementation, the system executes an activity classifier that classifies the engagement level of humans within the workspace (e.g., whether humans are actively working or simply present within a workspace) in order to provide data to administrators regarding whether the current arrangement of workstations within the workspace is correlated with higher engagement of humans within the workspace. More specifically, the system can classify human engagement at the workstation based on the feature vector, the set of significant objects, and an engagement classifier configured to classify an engagement level of a human occupying the workstation according to one of a set of engagement conditions including an engaged condition; a present condition; and an absent condition. The system can then: aggregate multiple classified engagement conditions generated over a time period into the set of engagement conditions; and calculate a workstation engagement rate based on the set of engagement conditions. Thus, the system can calculate a workstation engagement rate that can inform use-of-space recommendations generated by the system.

In another implementation, the system can: access the workspace context of the workspace in order to identify the workspace as a conference room; and can then execute an engagement classifier specific to conference rooms. More specifically, the system can: access a workspace context of the workspace, the workspace context indicating the workspace is a conference room; and classify human engagement at the workstation based on the feature vector, the set of significant objects, and an engagement classifier configured to classify an engagement level of a human occupying the workstation according to one of a group of engagement conditions including a presenting condition, a listening condition, a working condition, and an absent condition. Upon periodically executing the engagement classifier over a time period, the system can then: aggregate the engagement conditions into the set of engagement conditions for the workstation; and calculate a workstation engagement rate based on the set of engagement conditions. Thus, the system can accurately identify whether conference rooms are being utilized as intended by administrators of the workspace as a collaborative meeting environment, or whether conference rooms are instead being used as additional workspace for individuals or small groups.

In applications of the system to non-office-related workspaces (e.g., machine shops, assembly lines, laboratories), the system can execute additional activity classifiers particular to the functions performed by humans within these settings, thereby providing work-area-specific and workstation-specific space utilization data to administrators of the workspace. In each application, the system can access corresponding activity templates for input to each activity classifier along with the feature vector to generate an activity classification for an image of the workspace.

In one implementation, the system can execute activity classifiers that calculate a value of a similarity measure between an activity template corresponding to the activity classifier and the set of objects represented in the feature vector. More specifically, the system can: calculate a similarity measure between the set of significant objects and the set of objects represented in the feature vector; and classify human activity at the workstation based on the similarity measure to generate an activity classification. Additionally, the system can access a threshold value of the similarity measure corresponding to detection of particular conditions or activities within the workspace.

Alternatively, the system can increase accuracy of the activity classifiers while potentially increasing the risk of overfitting by including the set of significant objects defined by an activity template corresponding to the activity classifier in an input vector to the activity classifier. More specifically, the system can: generate an input vector including the feature vector and the set of significant objects; and classify human activity at the workstation based on the input vector and an activity classifier.

### 12. Workspace User Interface

Generally, the system can render (e.g., at a native application or internet browser application) a representation of the workstation at a workspace interface, the representation indicating occupancy of the workstation. More specifically, the system can render a map or other visual representation of a set of workstations in a workspace, thereby enabling an employee in the workspace to select a vacant desk in the workspace at which to work. In one implementation, the system can render a map indicating the location of each workstation within the workspace and an indication of the most recent occupancy classification of each workstation. In one example, the system indicates each classification (including occupied, vacant, and reserved) with a different color or symbol. Additionally or alternatively, the system can indicate the amount of time that a workstation has been occupied, reserved, or vacant in order to guide employees to potentially unoccupied or abandoned workstations. Thus, the system can render the representation of the workstation at the workspace, the representation of the workstation indicating the occupied state of the workstation distinct from the vacant state and the reserved condition.

In one implementation, the system can render, at the workspace interface, a representation of objects detected at workstations in the workspace in order to communicate to employees the status of the workstation beyond the occupancy classification of the workstation. For example, the system can render the position of laptops, chairs, desks, and humans relative to each workstation in the workspace.

### 13. Occupancy Data Reporting

Generally, the system can store feature vectors in association with the occupancy classification of each classified workstation and/or the original image from which the feature vector was generated. Thus, the system can generate a summary of objects that inform a classification of occupancy by the system. The summary can include statistics regarding the prevalence of particular objects for each classification time. For example, the system can generate a report indicating that 50% of all occupancy classifications were classified as reserved, indicating a low rate of utilization at unavailable workstations. In another example, the system can generate a report indicating that, for workstations classified as reserved, the frequency of laptops at the workstations is 65%. Therefore, the system can inform an administrator regarding these occupancy statistics, which are based on the feature vectors stored in association with an occupancy classification, so that the administrator may modify workstation policies, occupancy policies, or any other policy for a workspace.

Additionally, the system can store feature vectors corresponding to a particular workstation in association with activity classifications of humans occupying the particular workstation. Thus, the system can generate a report indicating an engagement rate of humans working at a particular workstation and/or the proportion of other activities detected at the workstation. More specifically, the system can: aggregate activity classifications, recorded over time, into a set of activity classifications in Block S180; and calculate a workstation activity statistic based on the set of activity classifications.

In one implementation in which the system executes an engagement classifier as the activity classifier, the system can: aggregate engagement conditions recorded for a workstation over time into a set of engagement conditions; and calculate an engagement rate for the workstation based on the set of engagement conditions. For example, the system can calculate that occupants of a particular workstation are only classified as exhibiting an engaged condition 40% of the time they are occupying the workstation. Thus, by providing these engagement statistics to an administrator of the system, the system enables administrators to make informed decisions regarding the placement and organization of workspaces within a workspace.

In another implementation in which the system executes an occupancy classifier, the system can: aggregate occupancy states of the workstation over a time period into a set of occupancy states; and calculate a workstation utilization rate for the workstation based on the set of occupancy states.

### 14. Use-of-Space Recommendations

Generally, the system can automatically generate a use-of-space recommendation for workspaces and/or workstations in order to improve utilization of a workspace in Block S190. Thus, the system can recommend specific steps to administrators of a workspace based on occupancy rates, engagement rates, and/or other rates of other activities classified within the workspace.

In one implementation, the system can receive, from an administrator of the system, a set of target utilization rates, engagement rates, and/or other rates of activities classified within the workspace. The system can then automatically detect when workstations and/or entire workspaces do not meet the target rates over a predetermined time period (e.g., a week, a month, a year). The system can then generate specific recommendations associated with the workstation or workspace to the user in response to detecting that the target rate has not been met.

In one example, the system can, in response to a target workstation utilization rate exceeding the workstation utilization rate, generate a recommendation to reduce a number of workstations within the workspace. In another example, the system can, in response to a target workstation engagement rate exceeding the workstation engagement rate, generate a recommendation to reduce distractions within the workspace. In yet another example, the system can, in response to a target workstation occupancy rate of a conference room exceeding a workstation occupancy rate of the conference room, generate a recommendation to reduce a size of the conference room.

### 15. Image-Based Classifier

In one implementation, the system can label images as occupied, occupied with no human present, and/or vacant based on the object detection model and the occupancy classifier, as described above. The system can then store the classification of each image in association with the original image from which this classification was generated as a training example for an image-based classifier specific to the workspace. The system can then train an image-based classifier in order to directly classify an image regarding the occupancy of a workstation in the image without an intermediate object detection step.

In one implementation, the system can define a confidence threshold for inclusion of a classification and an associated image as a training example. For example, the system can include only images for which the occupancy classifier indicates a classification with greater than 90% confidence.

### 16. Object Pairings

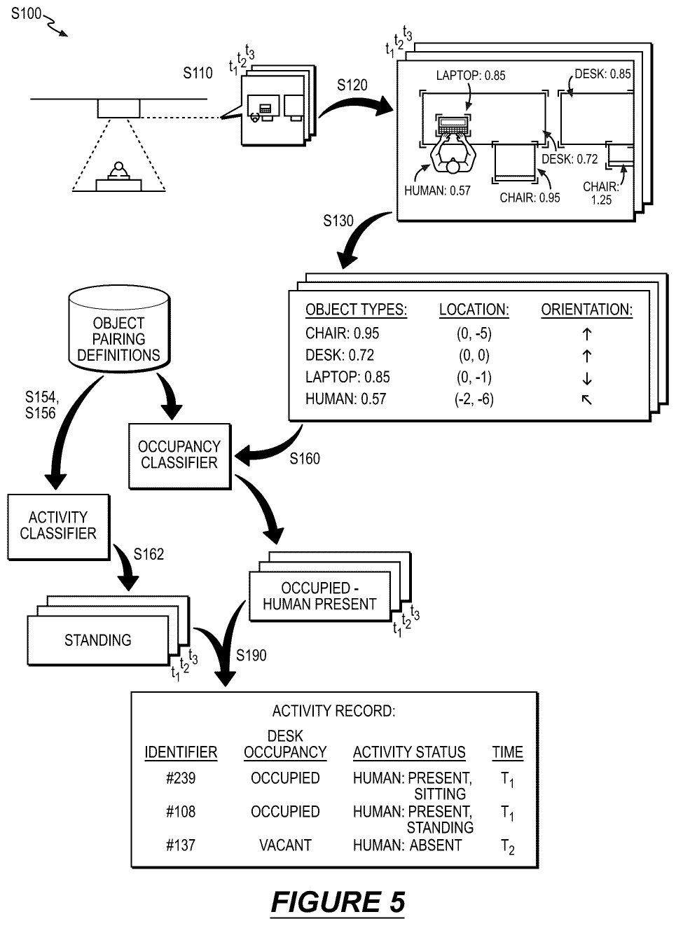

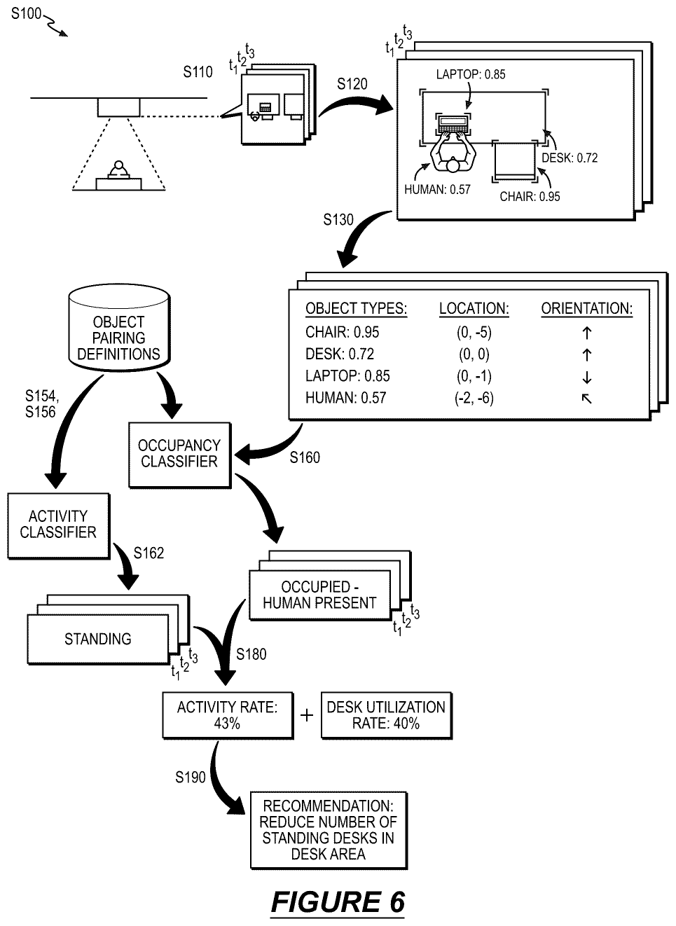

In one variation shown in FIGS. 5 and 6, the method S100 further includes: accessing a first occupancy definition associating an occupied state, a standing condition, and a first object pairing specifying a combination of object types and relative positions (e.g., a human object within a first threshold distance of a desk and further than second threshold distance of a chair) in Block S154; accessing a second occupancy definition associating an occupied state, a seated condition, and a second object pairing specifying a different combination of object types and relative positions (e.g., a human object within the first threshold distance of a desk and within the second threshold distance of a chair) in Block S156; accessing a third occupancy definition associating an occupied state, a human absent condition, and a third object pairing specifying a different combination of object types and relative positions (e.g., absence of a human object and presence of a personal effect within a third threshold distance of a desk); and/or accessing a fourth occupancy definition defining an unoccupied state and specifying a different combination of object types and relative positions (e.g., absence of a human object and personal effects within the third threshold distance of a desk).

Accordingly, in this variation, the system executing Blocks of the method can: access an image captured by a sensor block deployed in a workspace; detect objects in the image; and interpret types of these objects and their relative positions from the image. The system can then implement these occupancy definitions in order to distinguish desks that are: occupied with a human standing at the desk; occupied with a human sitting in a chair adjacent the desk; occupied with a human absent from the desk; and unoccupied (or “vacant”).

The system can implement similar methods to map other occupancy definitions—defined for desks, conference rooms (or tables in conference rooms specifically), lounges, and/or lobbies, etc.—to constellations of objects detected in images captured by sensor blocks deployed throughout the workplace in order to derive both occupancy states of these spaces and activities (or activity characteristics, actions) of humans occupying these spaces.

In particular, in this variation, the system can: access an occupancy definition that associates a particular occupancy state, a particular activity condition, and a particular object pairing (e.g., a cluster of objects, an arrangement of objects, a configuration of objects) for a workspace; and, based on the occupancy definition, associate a fixed object (e.g., a desk, a table) in the workspace with this particular occupancy state and particular activity state, as shown in FIGS. 5 and 6.

Therefore, rather than classifying occupancy of a workstation via the set of occupancy classifiers or classifying activities implemented by humans present at the workstation via the set of activity classifiers, the system can: associate occupancy, activities (e.g., posture statuses), and/or interaction events with individual fixed objects, an object pairing, and/or a configuration of objects (e.g., an arrangement of objects) present in a workspace according to a set of occupancy definitions.

Additionally, the system can: represent these occupancy states, activity conditions, and/or interaction events of fixed objects present in the workspace in an activity record for the workspace; update schedulers (or resource managers) according to the activity record for the workspace; and control various actuators throughout the workspace according to the activity record.

### 16.1 Occupancy Definition Examples

In one example shown in FIGS. 5 and 6, the system implements a standing desk occupancy definition that associates an occupied state, a standing condition, and an object pairing specifying: a human object within a first threshold distance range (e.g., 0.0 to 1.0 meter) of a desk object; and absence of a chair object within a second distance range (e.g., 0.0 to 0.5 meter)—of the human object.

In this example, the system implements a seated desk occupancy definition that associates an occupied state, a seated condition, and an object pairing specifying: a human object within the first threshold distance range (e.g., 0.0 to 1.0 meter) of a desk object; and a chair object within the second distance range (e.g., 0.0 to 0.5 meter) of the human object.

In this example, the system implements a human-absent desk occupancy definition that associates an occupied state, a human absence condition, and an object pairing specifying: a personal effect object (e.g., a hat, a garment, a computer, a notebook) within a third threshold distance range (e.g., 0.0 to 1.0 meter) of a desk object; and absence of a human chair object within a fourth distance range (e.g., 0.0 to 1.5 meter) of the desk object.

In this example, the system accesses a vacant occupancy definition that specifies absence of a personal effect object and a human object within the fourth threshold distance range (e.g., 0.0 to 1.5 meter) of a desk object.

Accordingly, in this example, the system can: access a first image recorded at a first sensor block at a first time, the first image depicting a first desk in a workspace and a second desk in the workspace; detect a first object of a first object type (e.g., a first human) depicted in the first image proximal the first desk; and detect a second object of a second object type (e.g., a first chair) depicted in the first image proximal the first desk. Then, in response to the first object pairing specifying the first object type and the second object type and in response to the first object falling within a first distance range of the second object, the system can associate the first desk with the occupied state and the standing condition at the first time according to the standing desk occupancy definition.

The system can similarly: detect a third object of the first object type (e.g., a second human) depicted in the first image proximal the second desk; and detect a fourth object of the second object type (e.g., a second chair) depicted in the first image proximal the second desk. Then, in response to the second object pairing specifying the first object type and the second object type and in response to the third object falling within a second distance range less than the first distance range of the fourth object, the system can associate the second desk with the occupied state and the seated condition at the first time according to the seated desk occupancy definition.

In this example, the system can further detect a fifth object of a personal effect object type (e.g., a hat, a garment, a computer, a notepad) depicted in the first image proximal a third desk. In response to the fifth object falling within a threshold distance of the third desk and in response to absence of a human proximal the third desk, the system can associate the third desk with the occupied state and the absent condition at the first time according to the human-absent desk occupancy definition.

Similarly, in response to detecting absence of objects of the first object type and the personal effect object type within the threshold distance of a fourth desk depicted in the first image, the computer system can associate the fourth desk with the vacant state at the first time according to the vacant occupancy definition.

### 16.2 Object Detection+Classification

In one implementation, the system can: detect a constellation of objects in an image captured by a sensor block; and, based on features detected in the image, detect an object type of each object in the constellation of objects and derive a position of each object in the constellation of objects. The system can then pair each object type of interest with a position in the field of view of the sensor block that recorded the corresponding image.

For example, the system can: extract a set of features from a region of an image proximal a fixed object (e.g., a desk, a table) depicted in the image; retrieve a set of template images representing a population of object types including a first object type (e.g., a human object type; a garment object type; a bag object type; and a hat object type and a second object type) and a second object type; and identify a first object depicted in the image as the first object type in response to matching a first template image—representing the first object type—in the set of template images, to the first set of features.

In one variation, each sensor block: detects objects in optical images of a workspace recorded by the sensor block, such as humans, chairs, desks, tables, or other objects of interest; and pairs each detected object of interest with a location and orientation in the field of view of an optical sensor, arranged in the sensor block, that recorded the corresponding image. Each sensor block can then classify occupancy, activities, and/or interaction events of individual detected objects, a detected object pairing, and/or a detected configuration of objects present in the workspace according to the set of occupancy definitions associating occupancy states, activity conditions, and/or interaction events with particular object pairings.

Furthermore, each sensor block can also detect various objects in the image, such as tables, desks, chairs, whiteboards, monitors or televisions, and/or cabinets, etc. The sensor block can then derive a state of a human occupant—present or absent—at a location within the field of view of the optical sensor based on types and relative positions of these objects to the human's location (or to the location of a cluster of personal effects interpreted as a unique human). For example, the sensor block can identify a human as working independently, eating, conversing, conferencing, walking, standing, seated, presenting, etc., based on the human's posture, proximity of personal effect object types and other object types proximal to the human, proximity of other humans to the human, and/or other features extracted from one image or from a series of images recorded by the sensor block during one scan cycle.

However, the sensor block can implement any other method or technique to qualify or quantify presence and/or occupancy of humans, personal effect object types, object types, and states of spaces within the field of view of the sensor block.

In another variation, the local gateway and/or computer system can: detect objects in optical images of a workspace recorded by a sensor block; and pair each detected object of interest with a location and orientation in the field of view of an optical sensor, arranged in the sensor block, that recorded the corresponding image. The local gateway and/or computer system can then classify occupancy, activities, and/or interaction events of individual detected objects, a detected object pairing, and/or a detected configuration of objects present in the workspace according to the set of occupancy definitions associating occupancy states, activity conditions, and/or interaction events with particular object pairings.

### 16.2.1 Terms: Personal Effect Object Types+Proximity

The method S100 is described herein as executed by a system to detect or identify objects of various object types proximal to a fixed object in a workspace—such as a table in a conference room, a desk in an agile work environment, or other work surface—within the field of view of the optical sensor in the sensor block. More specifically, the system can execute Blocks of the method S100 to detect or identify objects of a “personal effect” object type proximal to a fixed object within the field of view of the optical sensor in the sensor block. The system detects “personal effect” object types that can include personal items or other objects carried by humans in a work environment and that are detectable via Blocks of the method S100. These detectable “personal effect” object types or personal items can include but are not limited to: a garment object type such as shoes, jackets, and/or other wearable accessories; a bag object type; a hat object type; a keyboard object type; a computer object type; a monitor object type; a mug object type; and/or a book object type. Thus, the system can identify and detect personal items or objects as “personal effect” object types listed above and excluding objects (such as mobile objects or fixed objects) provided to the work environment by administrators or employers in the work environment.

Furthermore, the method S100 is described herein as executed by the system to detect objects of various object types “proximal” or “proximal to” fixed objects or locations within a work environment. Generally, “a first object of a first object type . . . proximal to the first desk refers” to presence of the first object within a threshold distance (e.g., two meters) of a fixed object (e.g., a table, a desk) or within a predefined area associated with the fixed object (e.g., a surface of a desk and a rectangular area in front of the desk). The system can: detect objects within a threshold distance or predefined area defined in association with the fixed object described as “proximal to” one another; and, in response to an object falling within a distance range of another object, execute Blocks of the method S100 to associate fixed objects with occupancy states, activity conditions, and/or other interaction events.

16.2.2 Occupancy with Human Present and Standing

In one variation, the system implements artificial intelligence and computer vision techniques described above to detect a constellation of objects in an image—depicting a desk in a workspace—captured by a sensor block arranged in the workspace. The system then extracts a set of features associated with the desk—such as within a predefined area or a bounding region assigned to the desk—from the image. Based on the set of features, the system: detects a first object of a first object type proximal the desk in the image; and detects a second object of a second object type proximal the desk in the image.

Accordingly, the system accesses a human-standing occupancy definition associating an occupied state, a standing condition, and an object pairing for the workspace. Responsive to the object pairing specifying the first object type and the second object type and responsive to the first object falling within a distance range of the second object, the system associates the first desk with the occupied state and the standing condition according to the human-standing occupancy definition.

For example, the system can: access an image captured by a sensor block and depicting a desk in a desk area; and extract a set of features within a bounding region of the desk—from the image. Based on the set of features, the system can: detect a first human of a first object type within a threshold distance (e.g., one meter) of a centroid of the desk; and detect a second chair of a second object type within the threshold distance of the centroid of the desk. In response to the first object pairing specifying the first object type and the second object type and in response to the human falling within a distance range of the chair, the system can associate the desk with an occupied state and the standing condition at the first time according to the human-standing occupancy definition.

Additionally, responsive to detecting presence of the human proximal the desk, the system can associate the desk with the occupied state according to the human-standing occupancy definition. Responsive to detecting the human, offset from the chair by a distance within the distance range and proximal the desk, the system can then associate the desk with the standing condition according to the human-standing occupancy definition.

Alternatively, in response to detecting the first human within a threshold human distance of the desk, the system can: associate the first human with the first desk; and associate the desk with the occupied state. Responsive to the chair falling within a threshold chair distance of the desk and responsive to the human falling within the distance range greater than a null distance (e.g., o meters) of the chair, the system can: associate the chair with the desk; identify the chair as unoccupied; and associate the desk with the standing condition.

Therefore, the system can: detect a constellation of objects analogous to the object pairing specified in the occupancy definition for the workspace and associate occupancy and activity conditions of human occupants with desks, tables, or other fixed objects in the workspace according to the occupancy definition.

16.2.3 Occupancy with Human Present and Seated

In another variation, the system accesses a human-present occupancy definition associating an occupied state, a seated condition, and an object pairing for the workspace. Responsive to an intersection of the constellation of objects and responsive to the first object of the first object type intersecting the second object of the second object type, the system: derives an occupancy state of the desk according to the human-present occupancy definition; and derives an activity condition of the second object according to the human-present occupancy definition.

For example, the system can: access an image captured by a sensor block and depicting a desk in a desk area; and extract a set of features within a bounding region of the desk from the image. Based on the set of features, the system can: detect a first human within a threshold distance (e.g., one meter) of a centroid of the desk; and detect a chair within the threshold distance of the centroid of the desk. Responsive to the object pairing specifying the first object type of the first human and the second object type of the chair and responsive to the chair falling within a distance range (e.g., 0.5 meters, 0.3 meters), the system can associate the desk with the occupied state and the seated condition according to the human-present occupancy definition.

Additionally, responsive to detecting presence of the human proximal the desk, the system can associate the desk with the occupied state according to the human-present occupancy definition. Responsive to detecting the human intersecting the chair, such as a positional overlap between the human and the chair and proximal to the desk, the system can then associate the desk with the seated condition according to the human-present occupancy definition.

Therefore, the system can: detect a constellation of objects analogous to the object pairing specified in the human-present occupancy definition for the workspace and characterize occupancy of desks, tables, or other fixed objects in the workspace according to the human-present occupancy definition. Additionally, rather than detecting an offset distance between a chair object type and a human object type, the system can detect a positional overlap (e.g., an intersection) between the chair object type and the human object type and identify a seated position of the human object type according to the human-present occupancy definition.

16.2.4 Occupancy with Human Absent

In another variation, the system accesses a human-absent occupancy definition associating an occupied state and an absent condition for the workspace. Responsive to detecting objects of a personal effect object type within a threshold distance of a fixed object and responsive to absence of humans proximal to the fixed object, the system can associate the desk with the occupied state and the absent condition.

For example, the system can: access a human-absent occupancy definition associating an occupied state and an absent condition; access a second image captured by the sensor block at a second time; and extract a second set of features within a bounding region of the desk—from the second image. Based on the second set of features, the system can: detect absence of a human within the threshold distance (e.g., one meter) of the centroid of the desk; and detect a second object of a personal effect object type within the threshold distance of the centroid of the desk. In response to the second object falling within the threshold distance of the desk and in response to detecting absence of humans within the threshold distance of the centroid of the desk, the system can associate the desk with the occupied state and the absent condition at the first time according to the occupancy definition.

### 16.2.5 Vacancy of Fixed Object

Furthermore, the system can interpret absence of humans, absence of personal effect object types, and/or presence of a chair—detected in an image—proximal the location of a particular fixed object (e.g., a desk, a table) as vacant.

For example, the system can: access a vacant occupancy definition associating a vacant state and an object pairing for the workspace; and implement methods and techniques described above to detect a first object of a chair object type within a threshold distance (e.g., one meter) of a desk (e.g., a second object of a desk object type) and detect absence of humans (e.g., objects of a human object type) within the threshold distance of the desk. In response to detecting absence of humans within the threshold distance of the desk, the system can derive an occupancy state of the particular desk as vacant or otherwise identify the particular desk as vacant.

Alternatively, the system can access a vacant occupancy definition for a vacant state. Then, in response to detecting absence of both humans and personal effect object types (e.g., hat, bag, garment, keyboard, computer, monitor, mug, and/or book object types) within a threshold distance of a desk, the system can associate the desk with the vacant state according to the vacant occupancy definition.

### 16.3 Object Pairing Interaction Classifier

In one variation, the system can execute a set of activity classifiers (e.g., implemented as artificial neural networks or other machine learning models, as described above) in order to classify interaction events between humans and/or other objects (e.g., a monitor, a television, a projector, a phone) present within the field of view of the sensor block.

### 16.3.1 Object Pairing Interaction Classifier: Presenting

In one implementation, the system interprets a scene—depicted in an image captured by a sensor block—as a human presenting to other humans. For example, the system can: access a presenting occupancy definition associating an occupied state, a presenting condition, and an object pairing for a workspace; access an image recorded at a sensor block and depicting a table in the workspace; and extract a set of features associated with the table from the image. Based on the set of features, the system can: detect an object of a first object type proximal (e.g., within a threshold distance of) the table; and detect a second object of a second object type proximal (e.g., within a threshold distance of) the table. Based on the presenting occupancy definition and in response to the first object of the first object type occupying a position within the threshold distance of the second object of the second object type, the system can associate the table with the occupied state and the presenting condition. The system can then represent the desk as occupied with a presenting occupant in an activity record associated with the workspace, as further described below.

In this example, the system can access an occupancy definition associating an occupied state, a presenting condition, and an object pairing for a conference room. The system can then: detect a human object type within a threshold distance (e.g., one meter) of the table; and detect a monitor object type within a threshold distance of (e.g., one meter) the table. In response to the human object type falling below a threshold distance of the monitor object type, and in response to the human object type and the monitor object type corresponding to the object pairing, the system can associate the table with the occupied state and the presenting condition. The system can then populate an activity record for the conference room with the occupied state and the presenting condition.

### 16.3.2 Object Pairing Interaction Classifier: Conferencing

In another implementation, the system accesses a conferencing occupancy definition associating an occupied state, a conferencing condition, and an object pairing for the workspace. The system then: detects a set of objects of a particular object type (e.g., a human object type) proximal a fixed object (e.g., a table in a conference room, a desk in a work area) within an image captured by a sensor block; matches this distribution of object types to the conferencing occupancy definition; associates the fixed object (or the space containing the fixed object) with the occupied state and a conferencing condition; and updates an activity record and/or a scheduler for the fixed object (or the space containing the fixed object) accordingly.

For example, the system can: access a conferencing occupancy definition associating an occupied state, a conferencing condition, and an object pairing for a conference room, such as specifying multiple instances of humans within a threshold distance (e.g., 0.3 meters, 0.5 meters) of a table within a conference room. In this example, the system can further: access an image of a conference room captured by a sensor block; detect a set of objects and their types depicted in the image, including a first human, a second human, and a table; and derive distances between these objects from the image. If these object types and relative distances fulfill the conferencing occupancy definition for a conference room, the system can associate the table—or the conference room more generally—with the occupied state and a conferencing condition. The system can further represent the table as occupied with multiple conferencing occupants in an activity record for the conference room.

In a similar example, the system can: access a conferencing occupancy definition associating an occupied state, a conferencing condition, and an object pairing for a desk, such as specifying multiple instances of humans within a threshold distance (e.g., 0.3 meters, 0.5 meters) of a desk and at least wo humans in this group occupying chairs. In this example, the system can further: access an image of a work area captured by a sensor block; detect a set of objects and their types depicted in the image, including a first human, a second human, a first chair, a second chair, and a desk; and derive distances between these objects from the image. If these object types and relative distances fulfill the conferencing occupancy definition for a desk, the system can associate the desk with the occupied state and a conferencing condition. The system can further represent the desk as occupied with multiple conferencing occupants in an activity record for the desk or the work area more generally.

In the foregoing example, the conferencing occupancy definition can also include a secondary object pairing—for the desk—that specifies multiple instances of humans within a threshold distance (e.g., 0.3 meters, 0.5 meters) of a desk for a threshold time duration and without a chair occupancy specification. In this example, the system can: access a first image of the work area captured by the sensor block; detect a first set of objects and their types depicted in the first image, including a first human, a second human, a first chair, and a desk; and derive distances between these objects from the first image. If the system detects no more than one human object type intersecting a chair in this first image, the system can thus reject the prior (or “primary”) object pairing for a desk. However, given presence of two human object types adjacent the desk, the system can flag the desk and initiate a timer. The system can then: access a second image of the work area captured by the sensor block; detect a second set of objects and their types depicted in the second image, including the first human, the second human, and the desk; and derive distances between these objects from the second image. If the system detects no more than one human object type intersecting a chair in this first image, the system can again reject the prior (or “primary”) object pairing for a desk. However, given presence of two human object types adjacent the desk and if the timer now indicates at least the threshold time duration, the system can associate the desk with the occupied state and a conferencing condition (i.e., two humans have been present adjacent the desk for at least a duration of time that indicates a longer or deeper conversation and thus warrants recordation as a conference). The system can further represent the desk as occupied with multiple conferencing occupants in an activity record for the desk, or the work area more generally, over this time duration.

### 16.4 Activity Record

Generally, each sensor block can: transform states and conditions of fixed objects-derived from images captured by the sensor block-into an activity record of these fixed objects, including their locations, occupancy states, and activity conditions of their occupants over time; and upload this activity record to the computer system for aggregation and/or publication for an administrator or other users affiliated with the space. (Alternatively, each sensor block can upload a vector or other map of object types and positions—detected in an image captured by the sensor block—to the computer system, and the computer system can execute subsequent processes described herein remotely to derive and publish activity records for such fixed objects. Alternatively, each sensor block can upload a raw image to the computer system, and the computer system can execute these processes remotely to derive and publish activity records for such fixed objects.)

In one implementation, each sensor block: generates a list, a matrix, or a table of desk locations of each desk detected in an image recorded by the sensor block, such as with each desk delineated by a latitude and longitude of a centroid of each desk in a local coordinate system implemented by the sensor block. Each sensor block then writes the occupancy state of each desk—derived by the sensor block—to a corresponding cell in the list, matrix, or table, such as a value for one of “occupied with human present,” “occupied with human absent,” or “vacant.” Each sensor block further writes the activity condition of each occupant—associated with the desk—to a corresponding cell in the list, matrix, or table, such as a value for one of “standing,” “seated,” “presenting,” or “conferencing.”

The computer system can then: transform each desk location—in this list, matrix, or table—in each sensor block coordinate system into a desk location in a global coordinate system for the agile work environment or for the facility more generally based on a known position and orientation of each sensor block in the agile work environment; and match each of these corrected desk locations to a known desk in the agile work environment, such as to associate each desk location indicated in this list, matrix, or table received from each sensor block with an unique identifier of one agile desk in the agile work environment.

For example, the sensor block can transmit, to the computer system: confirmation of present occupancy of a first subset of agile desks; confirmation of absent occupancy of a second subset of agile desks; confirmation of vacancy of a third subset of agile desks; and locations of the first, second, and third subsets of agile desks in the field of view of the optical sensor to the computer system. The computer system can then: generate a two-dimensional activity table for the desk area; populate the two-dimensional activity table with a first column including a first identifier of a first desk, a second identifier of a second desk, and a third identifier of a third desk; populate the two-dimensional activity table with a second column including the first occupancy state of the first desk, the second occupancy state of the second desk, and the third occupancy state of the third desk; and populate the two-dimensional activity table with a third column including a first activity condition of a first human proximal the first desk, a second activity condition of a second human proximal the second desk, and a third activity condition indicating absence of humans proximal the third desk.

However, each sensor block can transmit fixed object occupancy data and activity condition data in any other format prior to offloading these data to the computer system. Alternatively, rather than offloading fixed object occupancy data and activity condition data to the computer system, each sensor block can generate an activity record based on these fixed object occupancy data and activity condition data.

### 16.5 Capacity Limit Estimation

In one variation, the system detects objects of a particular object type in images captured by a sensor block arranged in a workspace and calculates a quantity of chairs present in the workspace based on these objects. The system can then estimate a capacity limit (e.g., a human occupancy limit) for the workspace proportional to the quantity of chairs present in the workspace.

For example, the system can: access an image captured by a sensor block and depicting a set of desks in a desk area; detect a first set of objects including a first chair within a threshold distance of a first desk in an image; detect a second set of objects including a second chair within the threshold distance of a second desk in the first image; and repeat these methods and techniques for each other desk in the set of desks. The system can then: calculate a quantity of chairs present in the desk area based on detection of the first chair and the second chair in the image; estimate a capacity limit for the workspace proportional to the quantity of chairs present in the desk area; and publish the capacity limit to a scheduler associated with the workspace.

Therefore, the system can estimate a capacity limit for each workspace in the space and/or the facility and publish these capacity limits to a scheduler to enable accurate team assignments, return-to-work policies, and space utilization planning for the facility without exceeding these capacity limits.

### 16.6 Desk Area Recommendations

In one implementation, the system can automatically generate a use-of-space recommendation for desk areas in order to improve desk utilization of each desk area. Thus, the system can recommend specific instructions to administrators of a desk area based on occupancy rates, activity rates, and/or other rates classified within the desk area.

In one variation, the system can automatically generate a recommendation to reduce or increase a number of standing desks in a workspace. For example, the system can execute Blocks of the method S100 to: associate a first desk with an occupied state and a standing condition at a first time; associate a second desk with the occupied state and a seated condition at the first time; later associate the first desk with a vacant state at a second time; and again associate the second desk with the occupied state and the seated condition at the second time. The system can then calculate a desk utilization rate for desks within this workspace during this time period based on these occupied and vacant states (e.g., 50% desk utilization rate for the first desk; 100% desk utilization rate for the second desk). The system can similarly: calculate a standing desk rate for desks within this workspace during this time period based on these standing and seated conditions (e.g., 100% standing rate for the first desk; 0% standing rate for the second desk). Therefore, the system can derive and aggregate for occupancy states and context of these occupancy states into metrics representing how and how much these desks are used over time.

Furthermore, responsive to the standing desk rate for the workspace falling below a target standing desk rate and responsive to the desk utilization rate exceeding a target desk utilization rate, the system can generate a recommendation to reduce a quantity of standing desks in the desk area. Thus, the system can automatically generate recommendations for desk areas in order to improve standing desk utilization of each desk area.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a first occupancy definition associating an occupied state, a standing condition, and a first object pairing;
accessing a second occupancy definition associating an occupied state, a seated condition, and a second object pairing;
accessing a first image recorded at a first sensor block at a first time, the first image depicting:
a first desk in a workspace; and
a second desk in the workspace;
detecting a first object of a first object type depicted in the first image proximal the first desk;
detecting a second object of a second object type depicted in the first image proximal the first desk;
in response to the first object pairing specifying the first object type and the second object type and in response to the first object falling within a first distance range of the second object:
associating the first desk with the occupied state and the standing condition at the first time according to the first occupancy definition;
detecting a third object of the first object type depicted in the first image proximal the second desk;
detecting a fourth object of the second object type depicted in the first image proximal the second desk; and
in response to the second object pairing specifying the first object type and the second object type and in response to the third object falling within a second distance range, less than the first distance range, of the fourth object:
associating the second desk with the occupied state and the seated condition at the first time according to the second occupancy definition.

2. The method of claim 1:
wherein detecting the first object of the first object type depicted in the first image comprises detecting the first object comprising a first human;
wherein detecting the second object of the second object type depicted in the first image comprises detecting the second object comprising a first chair;
wherein detecting the third object of the first object type depicted in the first image comprises detecting the third object comprising a second human;
wherein detecting the fourth object of the second object type depicted in the first image comprises detecting the fourth object comprising a second chair; and
further comprising:
accessing a third occupancy definition associating an occupied state and an absent condition;
accessing a fourth occupancy definition of a vacant state;
detecting a fifth object of a personal effect object type depicted in the first image proximal a third desk;
in response to the fifth object falling within a threshold distance of the third desk and in response to absence of a human proximal the third desk:
associating the third desk with the occupied state and the absent condition at the first time according to the third occupancy definition; and
in response to detecting absence of objects of the first object type and the personal effect object type within the threshold distance of a fourth desk depicted in the first image:
associating the fourth desk with the vacant state at the first time according to the fourth occupancy definition.

3. The method of claim 2, wherein detecting the fifth object of the personal effect object type depicted in the first image proximal the third desk comprises detecting the fifth object of the personal effect object type selected from the group of personal effect object types comprising:
a garment object type;
a bag object type;
a hat object type;
a keyboard object type;
a computer object type;
a monitor object type;
a mug object type; and
a book object type.

4. The method of claim 1:
wherein detecting the first object of the first object type depicted in the first image comprises detecting the first object comprising a first human;
wherein detecting the second object of the second object type depicted in the first image comprises detecting the second object comprising a first chair;
wherein detecting the third object of the first object type depicted in the first image comprises detecting the third object comprising a second human;
wherein detecting the fourth object of the second object type depicted in the first image comprises detecting the fourth object comprising a second chair; and
further comprising:
based on the occupied state and the standing condition of the first desk, representing the first desk as occupied with a standing occupant at the first time in an activity record associated with the workspace; and
based on the occupied state and the seated condition of the second desk, representing the second desk as occupied with a seated occupant at the first time in the activity record.

5. The method of claim 1, further comprising:
indicating a first location and the occupied state of the first desk at the first time in a scheduler;
indicating a second location and the occupied state of the second desk at the first time in the scheduler;
rendering the schedule on a display within the workspace;
calculating a standing desk rate for the workspace based on:
the standing condition of the first desk at the first time; and
the seated condition of the second desk at the first time; and
publishing the standing desk rate for the workspace separately from the scheduler.

6. The method of claim 1, further comprising:
accessing a third occupancy definition associating an occupied state, a conferencing condition, and a third object pairing;
accessing a second image recorded at a second sensor block at a second time and depicting a table in the workspace;
detecting a fifth object of the first object type depicted in the second image, the first object type corresponding to humans;
detecting a sixth object of the first object type depicted in the second image; and
in response to the third object pairing specifying multiple instances of the first object type and in response to the fifth object and the sixth object falling within a threshold distance of the table:
associating the table with the occupied state and the conferencing condition at the second time according to the third occupancy definition.

7. The method of claim 6:
wherein detecting the first object of the first object type depicted in the first image comprises detecting the first object comprising a first human;
wherein detecting the third object of the first object type depicted in the first image comprises detecting the third object comprising a second human;
wherein detecting the fifth object of the first object type depicted in the second image comprises detecting the fifth object comprising a third human;
wherein detecting the sixth object of the first object type depicted in the second image comprises detecting the sixth object comprising a fourth human; and
further comprising:
based on the occupied state and the standing condition of the first desk, representing the first desk as occupied with a standing occupant at the first time in an activity record associated with the workspace;
based on the occupied state and the seated condition of the second desk, representing the second desk as occupied with a seated occupant at the first time in the activity record; and
based on the occupied state and the conferencing condition of the table, representing the table as occupied with multiple occupants at the second time in the activity record.

8. The method of claim 1:
wherein detecting the first object of the first object type depicted in the first image comprises detecting the first object comprising a first human;
wherein detecting the second object of the second object type depicted in the first image comprises detecting the second object comprising a first chair;
wherein detecting the third object of the first object type depicted in the first image comprises detecting the third object comprising a second human;
wherein detecting the fourth object of the second object type depicted in the first image comprises detecting the fourth object comprising a second chair;
wherein associating the first desk with the occupied state and the standing condition comprises, according to the first occupancy definition:
associating the first desk with the occupied state in response to detecting presence of the first human proximal the first desk in the first image; and
associating the first desk with the standing condition in response to detecting the first human, offset from the first chair by a first distance within the first distance range, proximal the first desk in the first image; and
wherein associating the second desk with the occupied state and the seated condition comprises, according to the second occupancy definition:
associating the second desk with the occupied state in response to detecting presence of the second human proximal the second desk in the first image; and
associating the second desk with the seated condition in response to detecting the second human, intersecting the second chair, proximal the first desk in the first image.

9. The method of claim 1:
wherein detecting the first object of the first object type depicted in the first image comprises detecting the first object comprising a first human;
wherein detecting the second object of the second object type depicted in the first image comprises detecting the second object comprising a first chair; and
wherein associating the first desk with the occupied state and the standing condition comprises, according to the first occupancy definition:
in response to detecting the first human within a threshold human distance of the first desk:
associating the first human with the first desk; and
associating the first desk with the occupied state; and
in response to the first chair falling within a threshold chair distance of the first desk and in response to the first human falling within the first distance range, greater than a null distance, of the first chair:
associating the first chair with the first desk;
identifying the first chair as unoccupied; and
associating the first desk with the standing condition.

10. The method of claim 9, further comprising:
in response to detecting absence of a third chair within the threshold chair distance of a third desk detected in the first image:
flagging the third desk for absence of a corresponding chair;
generating an electronic notification indicating absence of a corresponding chair at the third desk; and
transmitting the electronic notification to an administrator associated with the workspace.

11. The method of claim 1, wherein detecting the first object of the first object type depicted in the first image proximal the first desk comprises, by the first sensor block:
extracting a first set of features from a first region of the first image proximal the first desk depicted in the first image;
retrieving a set of template images representing a population of object types, the population of object types, comprising the first object type and the second object type; and
identifying the first object as of the first object type in response to matching a first template image, in the set of template images, to the first set of features, the first template image representing the first object type.

12. The method of claim 1, further comprising:
accessing a third occupancy definition of a vacant state;
accessing a second image recorded at the first sensor block at a second time, the second image depicting the first desk;
detecting a fifth object of the second object type depicted in the second image proximal the first desk in the workspace; and
in response to absence of objects of the first object type, within the first distance range of the fifth object, depicted within the second image:
associating the first desk with the vacant state at the second time according to the third occupancy definition.

13. The method of claim 12, wherein detecting the first object of the first object type depicted in the first image comprises detecting the first object of the first object type selected from the group of object types comprising:
a human object type;
a garment object type;
a bag object type; and
a hat object type.

14. The method of claim 12, further comprising:
calculating a desk utilization rate for the workspace during a time period spanning the first time and the second time based on:
the occupied state of the first desk at the first time;
the occupied state of the second desk at the first time; and
the vacant state of the first desk at the second time;
calculating a standing desk rate for the workspace during the time period based on:
the standing condition of the first desk at the first time; and
the seated condition of the second desk at the first time; and
in response to the standing desk rate for the workspace falling below a target standing desk rate and in response to the desk utilization rate exceeding a target desk utilization rate:
generating a recommendation to reduce a quantity of standing desks in the workspace.

15. The method of claim 12, further comprising:
indicating a first location and the occupied state of the first desk at the first time in a scheduler;
indicating a second location and the occupied state of the second desk at the first time in the scheduler;
rendering the schedule on a display within the workspace; and
in response to associating the first desk with the vacant state at the second time, indicating the vacant state of the first desk at the second time in the scheduler.

16. The method of claim 1:
wherein detecting the second object of the second object type depicted in the first image comprises detecting the second object comprising a first chair;
wherein detecting the fourth object of the second object type depicted in the first image comprises detecting the fourth object comprising a second chair; and
further comprising:
calculating a quantity of chairs present in the workspace at the first time based on detection of the first chair and the second chair in the first image;
estimating a capacity limit for the workspace proportional to the first quantity of chairs present in the workspace; and
publishing the capacity limit to a scheduler associated with the workspace.

17. A method comprising:
accessing a first occupancy definition associating an occupied state, a standing condition, and a first object pairing;
accessing a second occupancy definition associating an occupied state, a seated condition, and a second object pairing;
accessing a first image recorded at a first sensor block at a first time, the first image depicting a first desk in a workspace;
detecting a first object of a first object type depicted in the first image proximal the first desk;
detecting a second object of a second object type depicted in the first image proximal the first desk;
in response to the first object pairing specifying the first object type and the second object type and in response to the first object falling within a first distance range of the second object:
associating the first desk with the occupied state and the standing condition at the first time according to the first occupancy definition;
accessing a second image recorded at the first sensor block at a second time, the second image depicting the first desk in the workspace;
detecting a third object of the first object type depicted in the second image proximal the first desk;
detecting a fourth object of the second object type depicted in the second image proximal the first desk; and
in response to the second object pairing specifying the first object type and the second object type and in response to the third object falling within a second distance range, less than the first distance range, of the fourth object:
associating the first desk with the occupied state and the seated condition at the second time according to the second occupancy definition.

18. The method of claim 17:
wherein detecting the first object of the first object type depicted in the first image comprises detecting the first object comprising a first human;
wherein detecting the second object of the second object type depicted in the first image comprises detecting the second object comprising a chair;
wherein detecting the third object of the first object type depicted in the second image comprises detecting the third object comprising a second human;
wherein detecting the fourth object of the second object type depicted in the second image comprises detecting the fourth object comprising the chair; and
further comprising:
accessing a third occupancy definition associating an occupied state and an absent condition;
accessing a fourth occupancy definition of a vacant state;
accessing a third image recorded at the first sensor block at a third time;
detecting a fifth object of a personal effect object type depicted in the third image proximal the first desk;
in response to the fifth object falling within a threshold distance of the first desk and in response to absence of a human proximal the first desk:
associating the first desk with the occupied state and the absent condition at the third time according to the third occupancy definition;
accessing a fourth image recorded at the first sensor block at a fourth time; and
in response to detecting absence of objects of the first object type and the human effect object type within the threshold distance of the first desk depicted in the fourth image:
associating the first desk with the vacant state at the fourth time according to the fourth occupancy definition.

19. A method comprising:
accessing a first occupancy definition associating an occupied state, a first activity condition, and a first object pairing;
accessing a second occupancy definition associating an occupied state, a second activity condition, and a second object pairing;
accessing a first image recorded at a first sensor block at a first time, the first image depicting:
a first work zone in a workspace; and
a second work zone in the workspace;
detecting a first object of a first object type depicted in the first image proximal the first work zone;
detecting a second object of a second object type depicted in the first image proximal the first work zone;
in response to the first object pairing specifying the first object type and the second object type and in response to the first object falling within a first distance range of the second object:
associating the first work zone with the occupied state and the first activity condition at the first time according to the first occupancy definition;
detecting a third object of the first object type depicted in the first image proximal the second work zone;
detecting a fourth object of the second object type depicted in the first image proximal the second work zone; and
in response to the second object pairing specifying the first object type and the second object type and in response to the third object falling within a second distance range, less than the first distance range, of the fourth object:
associating the second work zone with the occupied state and the second activity condition at the first time according to the second occupancy definition.

20. The method of claim 19:
wherein accessing the first occupancy definition comprises accessing the first occupancy definition associating the occupied state, the first activity condition comprising a standing condition, and the first object pairing specifying human object types and chair object types within the first distance range;
wherein accessing the second occupancy definition comprises accessing the second occupancy definition associating the occupied state, the second activity condition comprising a seated condition, and the second object pairing specifying human object types and chair object types within the second distance range, the second distance range less than the first distance range;
wherein detecting the first object of the first object type depicted in the first image comprises detecting the first object comprising a first human proximal the first work zone comprising a first desk;
wherein detecting the second object of the second object type depicted in the first image comprises detecting the second object comprising a first chair;
wherein detecting the third object of the first object type depicted in the first image comprises detecting the third object comprising a second human proximal the second work zone comprising a second desk;
wherein detecting the fourth object of the second object type depicted in the first image comprises detecting the fourth object comprising a second chair;
wherein associating the first work zone with the occupied state and the first activity condition at the first time comprises associating the first desk with the occupied state and the standing condition at the first time according to the first occupancy definition; and,
wherein associating the second work zone with the occupied state and the second activity condition at the first time comprises associating the second desk with the occupied state and the seated condition at the first time according to the second occupancy definition.
